(19) United States
(12) Patent Application Publication
(10) Pub. No.: US 2025/0308217 A1
(43) Pub. Date: Oct. 2, 2025

(54) IMAGE PROCESSING APPARATUS, IMAGE PROCESSING METHOD, AND IMAGE PROCESSING PROGRAM

(71) Applicant: FUJIFILM CORPORATION, Tokyo (JP)

(72) Inventors: Tatsuki KOIKE, Tokyo (JP); Kazuma TAKEMOTO, Chiba (JP)

(21) Appl. No.: 19/048,992

(22) Filed: Feb. 10, 2025

(30) Foreign Application Priority Data
Mar. 26, 2024 (JP) 2024-050491

(51) Int. Cl. G06V 10/774; G06T 5/50; G06T 5/73; G06T 11/00

(52) U.S. Cl. CPC G06V 10/774; G06T 5/50; G06T 5/73; G06T 11/005; G06T 2207/10081; G06T 2207/20081; G06T 2207/30004; G06T 2210/41; G06V 2201/031

(57) ABSTRACT

An image processing apparatus trains a machine learning model that receives input of a first two-dimensional medical image to output an organ recognition result for the first two-dimensional medical image, generates a second two-dimensional medical image based on a three-dimensional medical image obtained by imaging a subject, and trains the machine learning model using, as ground truth data, the generated second two-dimensional medical image and an organ recognition result corresponding to the second two-dimensional medical image based on an organ recognition result in the three-dimensional medical image.

### CROSS-REFERENCE TO RELATED APPLICATIONS

This application claims priority from Japanese Patent Application No. 2024-050491, filed on Mar. 26, 2024, the entire disclosure of which is incorporated herein by reference.

### BACKGROUND

### 1. Technical Field

The present disclosure relates to an image processing apparatus, an image processing method, and an image processing program.

### 2. Description of the Related Art

JP2023-065669A discloses a technology of inputting, to a trained model that outputs output information based on information including a disease name and a registration image of a subject, acquired information including a disease name and a registration image of a subject and outputting a scan range based on the output information.

### SUMMARY

In an imaging apparatus, such as a computed tomography (CT) apparatus, which captures a three-dimensional medical image a two-dimensional medical image called a scout image may be captured before the three-dimensional medical image is captured. In this case, an imaging range of the three-dimensional medical image is determined based on an organ recognition result for the two-dimensional medical image. Therefore, it is required to perform the organ recognition for the two-dimensional medical image with high accuracy. It should be noted that the scout image is also referred to as a scanogram.

For example, it is conceivable to use, for the organ recognition for the scout image, a trained model that has been trained using the scout image and the organ recognition result in the scout image as ground truth data. However, in the two-dimensional medical image such as the scout image, it may be difficult for a person to visually recognize an image depending on an organ. Therefore, in the trained model that has been trained using the two-dimensional medical image obtained by imaging the subject, there is room for improvement in the accuracy of the organ recognition.

The present disclosure has been made in view of the above-described circumstances, and an object of the present disclosure is to provide an image processing apparatus, an image processing method, and an image processing program, which can perform organ recognition for a two-dimensional medical image with high accuracy.

The present disclosure provides an image processing apparatus comprising: a processor, in which the image processing apparatus trains a machine learning model that receives input of a first two-dimensional medical image to output an organ recognition result for the first two-dimensional medical image, and the processor is configured to: generate a second two-dimensional medical image based on a three-dimensional medical image obtained by imaging a subject; and train the machine learning model using, as ground truth data, the generated second two-dimensional medical image and an organ recognition result corresponding to the second two-dimensional medical image based on an organ recognition result in the three-dimensional medical image.

In addition, the present disclosure provides an image processing method executed by a processor of an image processing apparatus that includes the processor and that trains a machine learning model that receives input of a first two-dimensional medical image to output an organ recognition result for the first two-dimensional medical image, the image processing method comprising: generating a second two-dimensional medical image based on a three-dimensional medical image obtained by imaging a subject; and training the machine learning model using, as ground truth data, the generated second two-dimensional medical image and an organ recognition result corresponding to the second two-dimensional medical image based on an organ recognition result in the three-dimensional medical image.

In addition, the present disclosure provides an image processing program causing a processor of an image processing apparatus that includes the processor and that trains a machine learning model that receives input of a first two-dimensional medical image to output an organ recognition result for the first two-dimensional medical image, to execute a process comprising: generating a second two-dimensional medical image based on a three-dimensional medical image obtained by imaging a subject; and training the machine learning model using, as ground truth data, the generated second two-dimensional medical image and an organ recognition result corresponding to the second two-dimensional medical image based on an organ recognition result in the three-dimensional medical image.

According to the present disclosure, it is possible to perform the organ recognition for the two-dimensional medical image with high accuracy.

### BRIEF DESCRIPTION OF THE DRAWINGS

FIG. 1 is a block diagram showing an example of a hardware configuration of an image processing apparatus.

FIG. 2 is a diagram showing a CT image and organ region information.

FIG. 3 is a diagram showing a recognition model according to a first embodiment.

FIG. 4 is a block diagram showing an example of a functional configuration of the image processing apparatus.

FIG. 5 is a diagram showing processing of generating a second three-dimensional medical image based on a first three-dimensional medical image.

FIG. 6 is a diagram showing processing of generating the organ region information.

FIG. 7 is a diagram showing processing of generating ground truth data.

FIG. 8 is a flowchart showing an example of training processing.

FIG. 9 is a perspective view showing an outline of a CT apparatus.

FIG. 10 is a block diagram showing an example of a hardware configuration of a console.

FIG. 11 is a block diagram showing an example of a functional configuration of the console.

FIG. 12 is a flowchart showing an example of organ recognition processing.

FIG. 13 is a diagram showing biological information according to a second embodiment.

FIG. 14 is a diagram showing a recognition model according to the second embodiment.

FIG. 15 is a diagram showing biological information according to a modification example.

FIG. 16 is a diagram showing the biological information according to the modification example.

FIG. 17 is a diagram showing an example of an organ recognition result according to the modification example.

### DETAILED DESCRIPTION

Hereinafter, form examples for carrying out the technology of the present disclosure will be described in detail with reference to the accompanying drawings.

### First Embodiment

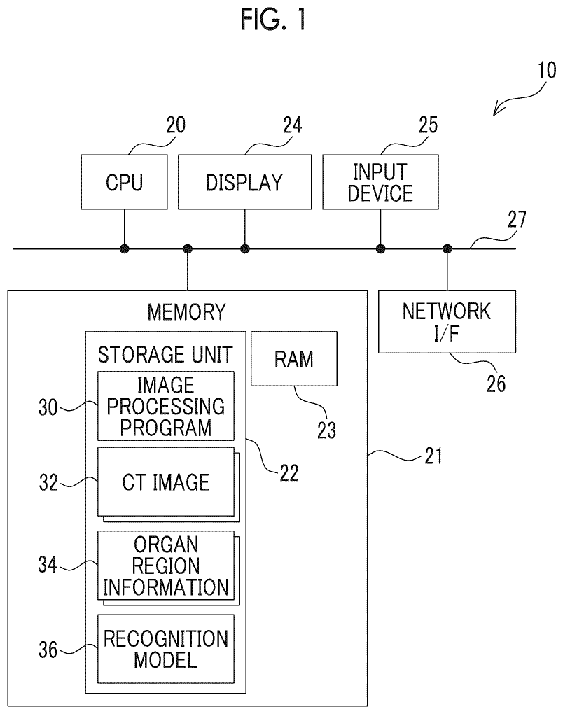

First, a training phase according to the present embodiment will be described. A hardware configuration of an image processing apparatus 10 according to the present embodiment will be described with reference to FIG. 1. As shown in FIG. 1, the image processing apparatus 10 includes a central processing unit (CPU) 20, a memory 21, a display 24, an input device 25, and a network interface (I/F) 26. Examples of the image processing apparatus 10 include a computer, such as a personal computer or a server computer.

The CPU 20 executes a program stored in a storage unit 22, which will be described below, to implement various functions. The CPU 20 is an example of a processor according to the technology of the present disclosure.

The memory 21 includes the storage unit 22 and a random access memory (RAM) 23. The RAM 23 is a primary storage memory, and is, for example, a RAM such as a static random access memory (SRAM) or a dynamic random access memory (DRAM).

The storage unit 22 is a non-volatile memory, and is implemented by, for example, at least one of a hard disk drive (HDD), a solid state drive (SSD), or a flash memory. The storage unit 22 as a storage medium stores an image processing program 30. The CPU 20 reads out the image processing program 30 from the storage unit 22, loads the image processing program 30 into the RAM 23, and executes the loaded image processing program 30.

The display 24 is a device that displays various screens and is, for example, a liquid crystal display or an electro luminescence (EL) display. The input device 25 is a device for a user to perform input, and is, for example, at least any of a keyboard, a mouse, a microphone for voice input, a touch pad for close-contact input including contact, or a camera for gesture input. The network I/F 26 is an interface for connecting to a network. The CPU 20, the memory 21, the display 24, the input device 25, and the network I/F 26 are connected to each other via a bus 27.

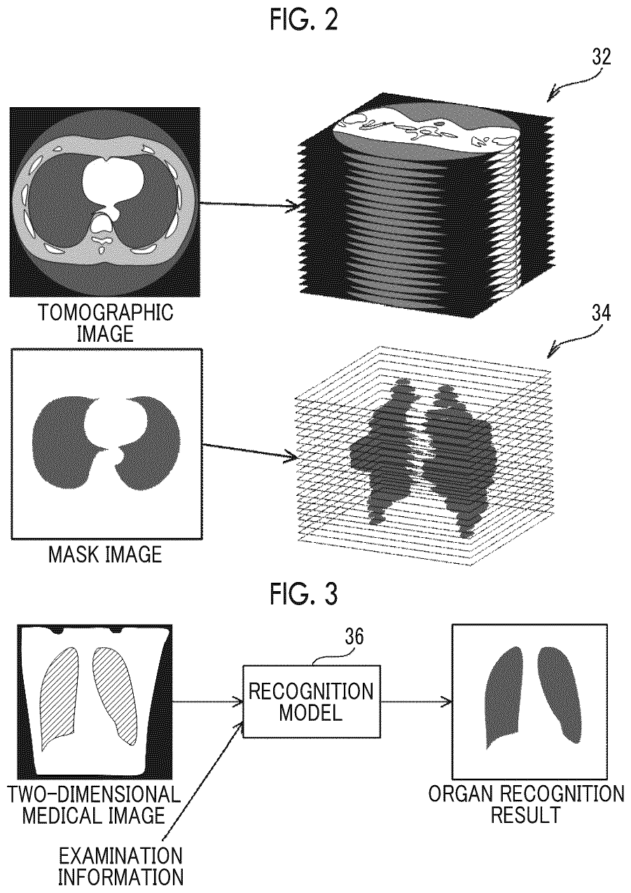

The storage unit 22 stores a CT image 32, an organ region information 34, and a recognition model 36. The CT image 32 is a three-dimensional image obtained by imaging a subject such as a patient using a CT apparatus. As shown in FIG. 2 as an example, the CT image 32 according to the present embodiment includes a tomographic image group representing an axial cross section perpendicular to a body axis direction of the subject. It should be noted that the tomographic image group may be a tomographic image group representing a cross section other than the axial cross section. The CT image 32 may be volume data. The CT image 32 is data used to train the recognition model 36, and a plurality of CT images 32 captured in advance are stored in the storage unit 22. The CT image 32 is an example of a three-dimensional medical image according to the technology of the present disclosure.

A plurality of pieces of organ region information 34 are prepared corresponding to the plurality of CT images 32. The organ region information 34 includes information indicating a range of an organ that is a recognition target in the corresponding CT image 32. As shown in FIG. 2 as an example, the organ region information 34 includes a mask image group in which an organ region in each tomographic image constituting the CT image 32 is filled with a specific color. The organ region information 34 corresponds to an organ recognition result corresponding to the CT image 32. The organ referred to herein also includes a bone, a blood vessel, and the like other than an organ located in a thoracic cavity and an abdominal cavity, such as a lung and a liver.

The recognition model 36 is a model that is trained by the image processing apparatus 10 through machine learning. As shown in FIG. 3 as an example, the recognition model 36 is a machine learning model that receives input of a first two-dimensional medical image to output an organ recognition result for the input first two-dimensional medical image. The recognition model 36 outputs information indicating a range of the recognized organ, as the organ recognition result. Specifically, the recognition model 36 outputs a mask image in which the organ region recognized from the input first two-dimensional medical image is filled with the specific color, as the organ recognition result. Further, the recognition model 36 also receives input of examination information in a case in which the CT image 32 is captured. Examples of the examination information include an examination target part or organ of the subject. For example, the examination information is added to the CT image 32. It should be noted that the recognition model 36 may be prepared for each examination information. In this case, the CPU 20 may use the recognition model 36 in accordance with the examination information.

In the present embodiment, an example will be described in which a radiation image obtained by irradiating the subject with radiation, such as X-rays, from a front surface to a back surface, that is, in a so-called anterior-posterior (AP) direction is applied as the first two-dimensional medical image. Examples of the first two-dimensional medical image input to the recognition model 36 include a scout image. That is, an imaging direction of the first two-dimensional medical image according to the present embodiment is the AP direction. The first two-dimensional medical image may be a radiation image obtained by irradiating the subject with radiation in a direction other than the AP direction, corresponding to a direction of a cross section of the CT image 32.

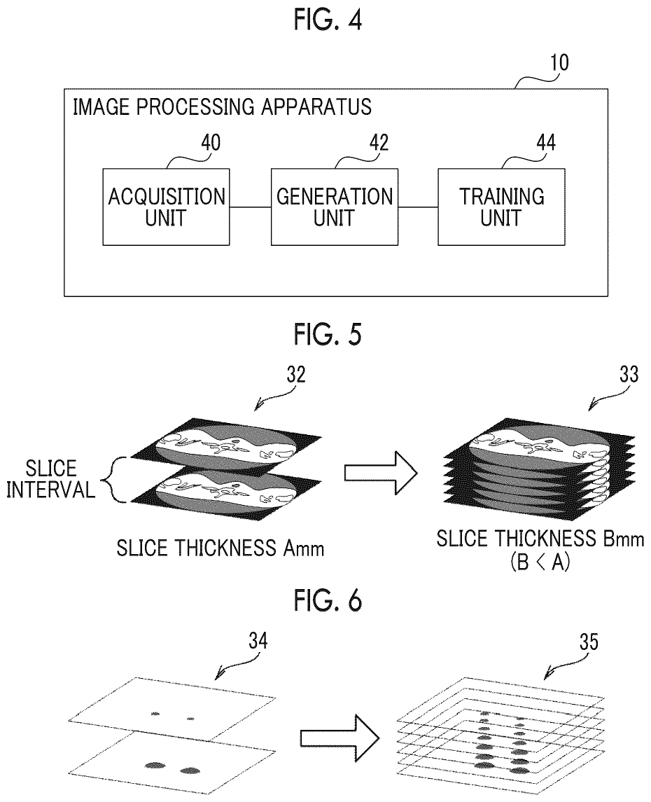

Subsequently, a functional configuration of the image processing apparatus 10 will be described with reference to FIG. 4. As shown in FIG. 4, the image processing apparatus 10 includes an acquisition unit 40, a generation unit 42, and a training unit 44. The CPU 20 executes the image processing program 30, to function as the acquisition unit 40, the generation unit 42, and the training unit 44.

The acquisition unit 40 acquires the CT image 32 and the organ region information 34 from the storage unit 22. The generation unit 42 generates a CT image 33 based on the CT image 32 acquired by the acquisition unit 40. Hereinafter, a specific example of processing of generating the CT image 33 via the generation unit 42 will be described.

The generation unit 42 generates the CT image 33 having a narrower slice interval or a thinner slice thickness than the CT image 32, based on the CT image 32. As an example, as shown in FIG. 5, the generation unit 42 according to the present embodiment generates the CT image 33 having a narrower slice interval and a thinner slice thickness than the CT image 32, based on the CT image 32. The slice interval means a distance between the tomographic images in a specific direction. The specific direction is a direction intersecting the cross section represented by the tomographic image, and corresponds to the body axis direction in a case in which the tomographic image is an image representing the axial cross section. In addition, in a case in which the tomographic image is an image representing a coronal cross section, the AP direction corresponds to the specific direction. Further, the slice thickness means a thickness of each tomographic image along the specific direction of the information. For example, the tomographic image representing the axial cross section having the slice thickness of 5 mm represents information on an organ extending 2.5 mm above and below in the body axis direction as a single image.

For example, the generation unit 42 generates the CT image 33 from the CT image 32 using a virtual thin slice method described in Reference 1. As a result, the CT image 33 having a higher resolution than the CT image 32 is generated. The CT image 32 is an example of a first three-dimensional medical image according to the technology of the present disclosure, and the CT image 33 is an example of a second three-dimensional medical image according to the technology of the present disclosure.

Reference 1: Virtual Thin Slice: 3D Conditional GAN-based Super-resolution for CT Slice Interval, Akira Kudo et al., 30 Aug. 2019, arXiv: 1908.11506.

In addition, as shown in FIG. 6, the generation unit 42 generates organ region information 35, which is a mask image group corresponding to the CT image 33, based on the CT image 32, the CT image 33, and the organ region information 34. The organ region information 35 corresponds to an organ recognition result corresponding to the CT image 33 based on the CT image 32.

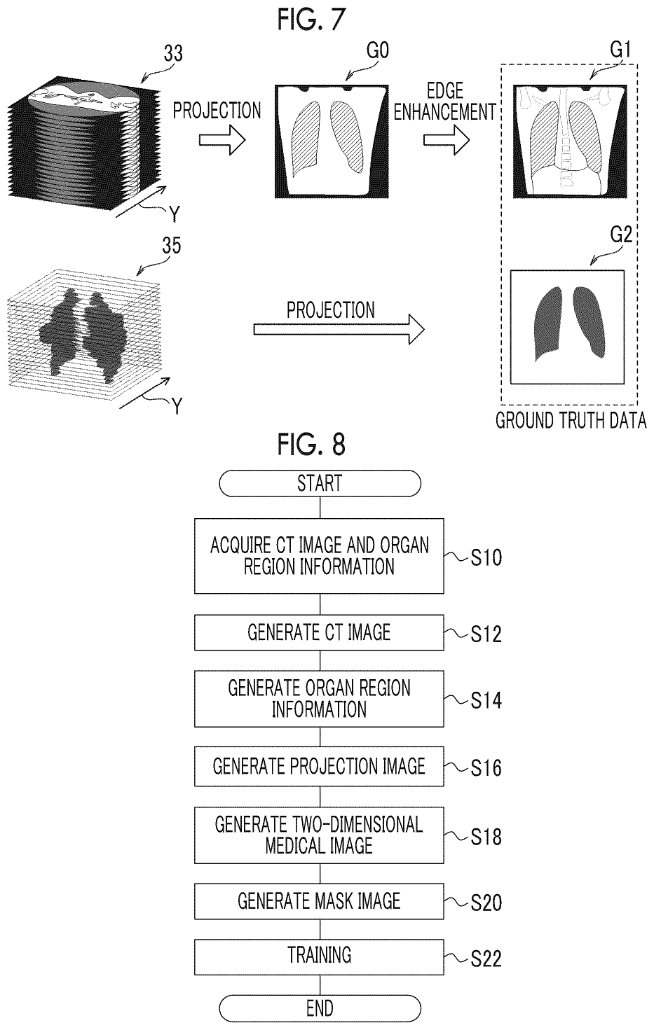

Subsequently, as shown in FIG. 7, the generation unit 42 generates a two-dimensional projection image G0 by projecting the CT image 33 in a direction (hereinafter, referred to as a “projection direction”) corresponding to the imaging direction of the first two-dimensional medical image. In the example of FIG. 7, the projection direction is indicated by an arrow Y. The projection image G0 is also referred to as a ray-sum image. Then, the generation unit 42 generates a two-dimensional medical image G1 by performing image processing of enhancing an edge on the projection image G0. That is, the generation unit 42 generates the two-dimensional medical image G1 by performing image processing of enhancing the edge based on the CT image 33. The two-dimensional medical image G1 generated in this way is a pseudo scout image that simulates the scout image captured by the CT apparatus. The two-dimensional medical image G1 is an example of a second two-dimensional medical image according to the technology of the present disclosure.

It should be noted that the generation unit 42 may perform different image processing depending on the imaging apparatus used to capture the three-dimensional medical image or the organ that is the recognition target. For example, the generation unit 42 may perform image processing of enhancing the edge in accordance with a degree of enhancement set in advance for each imaging apparatus. In addition, the generation unit 42 may perform image processing of enhancing the edge in accordance with the degree of enhancement set in advance for each organ that is the recognition target. For example, the generation unit 42 may perform image processing of relatively increasing the degree of enhancement to enhance the edge for an organ having a bone, such as a head, and perform image processing of relatively decreasing the degree of enhancement to enhance the edge for the lung. As a result, the generation unit 42 can generate the two-dimensional medical image G1 that is more similar to the scout image, depending on the characteristics of the imaging apparatus or the organ that is the recognition target.

In addition, as shown in FIG. 7, the generation unit 42 projects the organ region information 35 in the same direction as the projection direction in a case of generating the projection image G0, to generate a mask image G2 representing an organ recognition result corresponding to the two-dimensional medical image G1.

The training unit 44 trains the recognition model 36 using, as ground truth data, the two-dimensional medical image G1 and the mask image G2 that are generated by the generation unit 42. For example, the training unit 44 trains the recognition model 36 so that an error between the output of the recognition model 36 in a case in which the examination information and the two-dimensional medical image G1 are input to the recognition model 36 and the mask image G2 corresponding to the two-dimensional medical image G1 is minimized. The training unit 44 trains the recognition model 36 using a plurality of sets of ground truth data based on a plurality of sets of CT images 32 and pieces of organ region information 34.

Subsequently, the operation and effect of the image processing apparatus 10 will be described with reference to FIG. 8. In a case in which the CPU 20 executes the image processing program 30, training processing shown in FIG. 8 is executed. This training processing is executed, for example, in a case in which an instruction to start the execution is input by the user.

In step S10 in FIG. 8, the acquisition unit 40 acquires the CT image 32 and the organ region information 34 from the storage unit 22. In step S12, the generation unit 42 generates the CT image 33 based on the CT image 32 acquired in step S10, as described above. In step S14, the generation unit 42 generates the organ region information 35 corresponding to the CT image 33 based on the CT image 32, the CT image 33, and the organ region information 34.

In step S16, the generation unit 42 generates the projection image G0 by projecting the CT image 33 in the projection direction. In step S18, the generation unit 42 generates the two-dimensional medical image G1 by performing image processing of enhancing the edge on the projection image G0. In step S20, the generation unit 42 generates the mask image G2 corresponding to the two-dimensional medical image G1 by projecting the organ region information 35 in the same direction as the projection direction in a case of generating the projection image G0.

In step S22, as described above, the training unit 44 trains the recognition model 36 using, as the ground truth data, the two-dimensional medical image G1 generated in step S18 and the mask image G2 generated in step S20. In a case in which the processing in step S22 ends, the training processing ends.

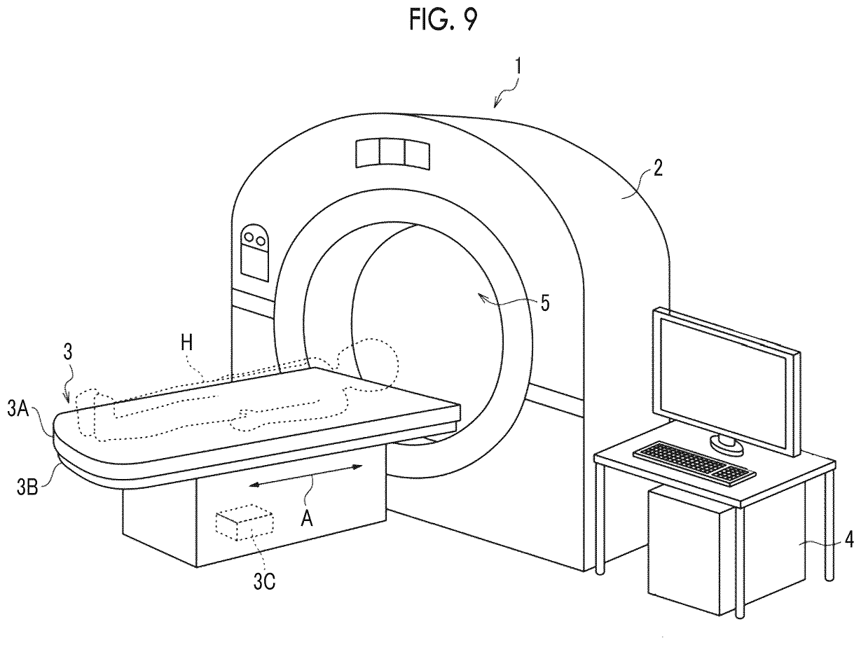

Next, an operation phase using the recognition model 36 trained by the training phase will be described. A configuration of the CT apparatus 1 will be described with reference to FIG. 9. As shown in FIG. 9, the CT apparatus 1 according to the present embodiment comprises a gantry 2, an examination table 3, and a console 4. The console 4 is an example of an image processing apparatus according to the technology of the present disclosure. It should be noted that the console 4 and the image processing apparatus 10 may be different apparatuses. In addition, for example, the image processing apparatus 10 may be connected to an image storage server that acquires and stores an image from the console 4 or from the console 4 via the network. Further, for example, the image processing apparatus 10 may be configured to acquire the scout image from the console 4 or the image storage server and output the organ recognition result of the scout image to the console 4 or the image storage server.

The gantry 2 has a tunnel-shaped structure with an opening part 5 at the center thereof. Inside the gantry 2, a radiation source unit that emits X-rays and a detection unit that detects the X-rays to generate the radiation image are provided (neither of which is shown). The radiation source unit and the detection unit can be each rotated along an annular shape of the gantry 2 in a state of maintaining a positional relationship in which the radiation source unit and the detection unit face each other. Further, a controller that controls an operation of the CT apparatus 1 is provided inside the gantry 2.

A subject H is placed on the examination table 3. The examination table 3 includes an examination table part 3A on which the subject H lies down, a base part 3B that supports the examination table part 3A, and a driving part 3C that reciprocally moves the examination table part 3A in an arrow A direction. The examination table part 3A can be slid with respect to the base part 3B in the arrow A direction via the driving part 3C. In a case in which the CT image is captured, the examination table part 3A is slid, and the subject H lying down on the examination table part 3A is transported into the opening part 5 of the gantry 2.

The driving of the gantry 2 and the driving of the examination table 3 are performed by the input of the user, such as a technician, from the console 4.

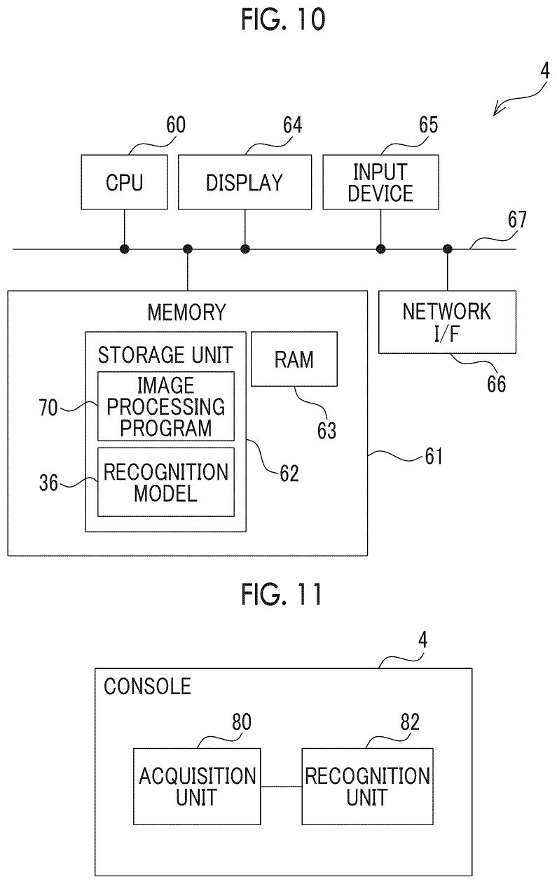

Subsequently, a hardware configuration of the console 4 according to the present embodiment will be described with reference to FIG. 10. As shown in FIG. 10, the console 4 includes a CPU 60, a memory 61, a display 64, an input device 65, and a network I/F 66. Examples of the console 4 include a computer, such as a personal computer or a server computer.

The CPU 60 executes a program stored in a storage unit 62, which will be described below, to implement various functions. The CPU 60 is an example of a processor according to the technology of the present disclosure.

The memory 61 includes the storage unit 62 and a RAM 63. The RAM 63 is a primary storage memory, and is, for example, a RAM such as an SRAM or a DRAM.

The storage unit 62 is a non-volatile memory, and is implemented by, for example, at least one of an HDD, an SSD, or a flash memory. The storage unit 62 as a storage medium stores an image processing program 70. The CPU 60 reads out the image processing program 70 from the storage unit 62, loads the image processing program 70 into the RAM 63, and executes the loaded image processing program 70.

The display 64 is a device that displays various screens and is, for example, a liquid crystal display or an EL display. The input device 65 is a device for a user to perform input, and is, for example, at least any of a keyboard, a mouse, a microphone for voice input, a touch pad for close-contact input including contact, or a camera for gesture input. The network I/F 66 is an interface for connecting to a network. The console 4 performs various types of communication with the controller provided in the gantry 2 via the network I/F 66. The CPU 60, the memory 61, the display 64, the input device 65, and the network I/F 66 are connected to each other via a bus 67.

Further, the recognition model 36 is stored in the storage unit 62. The recognition model 36 is an example of a trained model that has been trained by the training phase described above.

Subsequently, a functional configuration of the console 4 will be described with reference to FIG. 11. As shown in FIG. 11, the console 4 includes an acquisition unit 80 and a recognition unit 82. The CPU 60 executes the image processing program 70, to function as the acquisition unit 80 and the recognition unit 82.

The acquisition unit 80 acquires a two-dimensional medical image captured by irradiating the front surface to the back surface of the subject H with radiation using the CT apparatus 1. This two-dimensional medical image is referred to as the scout image. In addition, the acquisition unit 80 acquires the examination information of the subject H from an imaging order or the like stored in the storage unit 62.

The recognition unit 82 inputs the examination information and the two-dimensional medical image that are acquired by the acquisition unit 80 to the recognition model 36. As a result, the recognition model 36 outputs an organ recognition result corresponding to the input examination information and two-dimensional medical image. The recognition unit 82 recognizes an organ range in the two-dimensional medical image by acquiring the organ recognition result output from the recognition model 36.

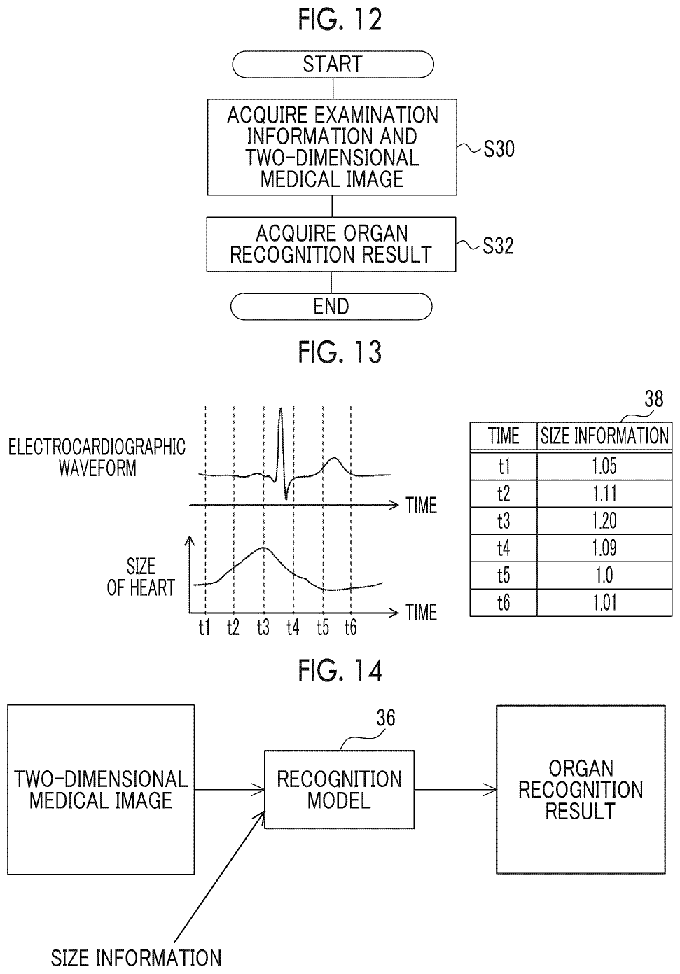

Subsequently, the operation and effect of the console 4 will be described with reference to FIG. 12. In a case in which the CPU 60 executes the image processing program 70, organ recognition processing shown in FIG. 12 is executed. The organ recognition processing is executed, for example, in a case in which an instruction to start the execution is input by the user.

In step S30 in FIG. 12, the acquisition unit 80 acquires the examination information and the two-dimensional medical image, as described above. In step S32, the recognition unit 82 inputs the examination information and the two-dimensional medical image acquired in step S30 to the recognition model 36, to acquire the organ recognition result for the two-dimensional medical image. In a case in which the processing of step S32 ends, the organ recognition processing ends. The organ range recognized by the organ recognition processing is used to determine the imaging range of the CT image captured by the CT apparatus 1.

As described above, according to the present embodiment, it is possible to perform the organ recognition for the two-dimensional medical image with high accuracy.

### Second Embodiment

A second embodiment of the technology of the present disclosure will be described. In the present embodiment, since the recognition model 36, the function of the training unit 44, and the recognition unit 82 are different from those in the first embodiment, the recognition model 36, the function of the training unit 44, and the recognition unit 82 will be described. The present embodiment is different from the first embodiment in that biological information of the subject is used as the input with respect to the recognition model 36. In addition, in the present embodiment, as an example, a case will be described in which the organ that is the recognition target is the heart and the biological information of the subject is size information representing a size of the heart.

As shown in a graph of FIG. 13 as an example, an electrocardiographic waveform and the size of the heart can be associated with each other. In the present embodiment, biological data 38 is stored in the storage unit 22 of the image processing apparatus 10. As shown in FIG. 13, in the biological data 38, the size information indicating the size of the heart is stored corresponding to each of times t1 to t6 of the electrocardiographic waveform. In the present embodiment, the size information is represented by a ratio of the size of the heart. The ratio of the size of the heart is represented by a ratio in which the size at the minimum timing is set to 1. It should be noted that the biological data 38 may be based on past measurement data of the subject. Further, the biological data 38 may be, for example, based on general measurement data such as an average value of measurement data of a plurality of subjects having the same physique and gender as the subject. In addition, in the present embodiment, it is assumed that the CT image 32 is added with timing information indicating which timing of the times t1 to t6 the CT image 32 is captured.

As shown in FIG. 14, the recognition model 36 according to the present embodiment is a machine learning model that receives the input of the size information indicating the size of the organ that is the recognition target and the first two-dimensional medical image to output the organ recognition result for the input first two-dimensional medical image.

The training unit 44 according to the present embodiment further trains the recognition model 36 using the size information in a case in which the CT image 32 is captured. Specifically, the training unit 44 refers to the biological data 38 to acquire the size information corresponding to the timing information added to the CT image 32 used to generate the two-dimensional medical image G1. Then, the training unit 44 trains the recognition model 36 so that an error between the output of the recognition model 36 in a case in which the size information and the two-dimensional medical image G1 are input to the recognition model 36 and the mask image G2 corresponding to the two-dimensional medical image G1 is minimized.

In the present embodiment, as an example, a case will be described in which the subject wears an electrocardiographic sensor during capturing of the two-dimensional medical image in the operation phase. The recognition unit 82 according to the present embodiment specifies which of the times t1 to t6 corresponds to a timing at which the two-dimensional medical image is captured, based on an acquisition time point of the electrocardiographic waveform measured by the electrocardiographic sensor and an imaging time point of the two-dimensional medical image. The recognition unit 82 acquires the size information corresponding to the specified timing from the biological data 38.

The recognition unit 82 inputs the acquired size information and the two-dimensional medical image acquired by the acquisition unit 80 to the recognition model 36, to acquire the organ recognition result for the two-dimensional medical image.

As described above, according to the present embodiment, it is possible to perform the organ recognition for the two-dimensional medical image with high accuracy based on the biological information of the subject.

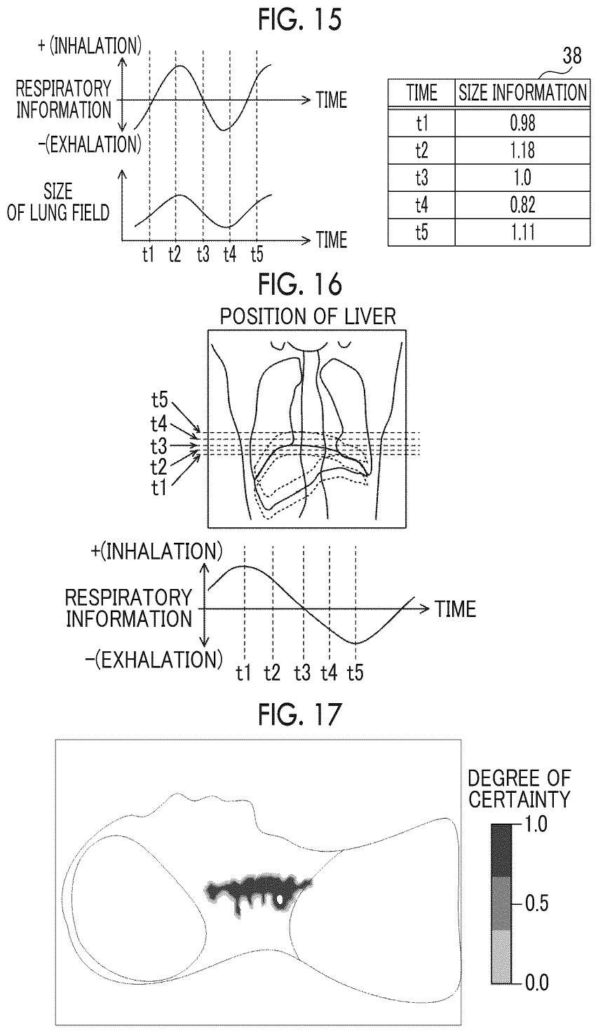

It should be noted that, in the second embodiment, a lung field may be applied as the organ that is the recognition target, and size information representing a size of the lung field may be applied as the biological information of the subject. As shown in a graph of FIG. 15 as an example, respiratory information of the subject and the size of the lung field can be associated with each other. In this form example, as shown in FIG. 15, in the biological data 38, the size information indicating the size of the lung field is stored corresponding to each of the times t1 to t5 of the respiratory information. In the present embodiment, the size information is represented by a ratio of the size of the lung field. In addition, the ratio of the size of the lung field is represented by a ratio in which a size at an intermediate timing in one period of respiratory is set to 1. In this form example, the training unit 44 and the recognition unit 82 use the respiratory information and the size information indicating the size of the lung field, instead of using the electrocardiographic waveform and the size information indicating the size of the heart in the second embodiment.

In addition, in the second embodiment, a liver may be applied as the organ that is the recognition target, and positional information indicating a position of the liver in the body axis direction (that is, the up-down direction in the two-dimensional medical image) may be applied as the biological information of the subject. As shown in FIG. 16 as an example, the respiratory information of the subject and the positional information of the liver can be associated with each other. In this form example, in the biological data 38, the positional information of the liver is stored corresponding to each of the times t1 to t5 of the respiratory information. In this form example, the training unit 44 and the recognition unit 82 use the respiratory information and the positional information of the liver instead of using the electrocardiographic waveform and the size information representing the size of the heart in the second embodiment.

In addition, in each of the above-described embodiments, the recognition unit 82 may use, in a differentiated manner, a first recognition model 36 trained using the two-dimensional medical image G1 generated based on the CT image 32 and a second recognition model 36 trained using the two-dimensional medical image actually captured by irradiating the subject with radiation. In this case, the recognition unit 82 may acquire the organ recognition result by using the second recognition model 36 for the organ set as an easily visible organ in the two-dimensional medical image captured by the CT apparatus 1. In addition, in this case, the recognition unit 82 may acquire the organ recognition result by using the first recognition model 36 for an organ (for example, a spinous process of a cervical spine) set as a less visible organ in the two-dimensional medical image captured by the CT apparatus 1. In addition, the CPU 60 may perform control of displaying, in an identifiable manner, the organ recognition result obtained by using the first recognition model 36 and the organ recognition result obtained by using the second recognition model 36. In this case, it is possible for the user to identify a portion that can be recognized from the two-dimensional medical image and a portion that can be recognized from the three-dimensional medical image in the organ recognition result.

In addition, in each of the above-described embodiments, as shown in FIG. 17 as an example, the CPU 60 may identify a degree of certainty by filling the range of the recognized organ with a different color in accordance with the degree of certainty instead of filling the range of the recognized organ with the specific color, as the organ recognition result. The degree of certainty of the organ is an example of an indicator value indicating a degree of possibility of being within the range of the organ. FIG. 17 shows an example of an organ recognition result in a case in which the imaging direction is a left-right direction of the subject and the cervical spine is applied as the organ that is the recognition target in this form example. A portion in which a boundary is unclear on the scout image often has a thin thickness in the imaging direction, and the degree of certainty of the portion in which the boundary is unclear tends to be decreased. Therefore, the CPU 60 can display a three-dimensional structure of the organ in an ascertainable manner by performing control of displaying the range of the recognized organ in different display aspects in accordance with the degree of certainty. The display aspect referred to herein includes not only the color but also the transparency, a thickness of a frame line, a type of the frame line, and the like.

In addition, in each of the above-described embodiments, the case has been described in which the CT image is applied as the three-dimensional medical image, but the technology of the present disclosure is not limited to this aspect. A three-dimensional image captured by a magnetic resonance imaging (MRI) apparatus or a three-dimensional image captured by a positron emission tomography (PET) apparatus may be applied as the three-dimensional medical image.

In addition, in each of the above-described embodiments, in a case in which the three-dimensional medical image is an MRI image, the three-dimensional medical image may include a tomographic image group having a thinner slice thickness and a narrower slice interval than the scout image that is an example of the two-dimensional medical image.

In this embodiment, each process is executed on an arbitrary computer. The arbitrary computer may execute these processes by means of a processor as hardware, a program as software, or a combination of the processor and the program. In such a case, the processor is configured to execute the various processes in this embodiment in cooperation with the program and may function as each unit or means in this embodiment. In addition, the order in which the processor executes these processes is not limited to the order described in this embodiment and may be changed as appropriate. The arbitrary computer may be a general-purpose computer, a computer for a specific purpose, a workstation, or any other system capable of executing each process.

The processor may be configured by one or more hardware, and the type of hardware is not limited. For example, the processor may comprise at least one of programmable logic devices such as CPUs (Central Processing Units), MPUs (Micro Processing Units), and FPGAs (Field Programmable Gate Arrays); dedicated circuits for performing specific processes such as ASICs (Application Specific Integrated Circuits); and other hardware such as a GPU (Graphics Processing Unit) and an NPU (Neural Processing Unit). The hardware may also be a combination of different types of hardware. When multiple hardware are configured to execute one or more processes of a processor, the said multiple hardware may exist in devices that are physically separate from each other, or in the same device. In any embodiment, the order of each process by the processor is not limited to the order described above and may be changed as appropriate. The hardware is configured by an electric circuit (circuitry) etc. that combines circuit elements such as semiconductor devices.

Furthermore, the program may be firmware or software such as microcode. The program may also be a group of program modules, each function of which may be performed by a processor configured to execute each of the program modules. The program may be program code or code segments stored on one or more non-transitory computer-readable media (e.g., storage media or other storage). The program may be stored in separate non-transitory computer-readable media located on devices that are physically separate from each other. The program code or code segments may represent any combination of procedures, functions, subprograms, routines, subroutines, modules, software packages, classes, instructions, data structures, or program statements. The program code or code segments may be connected to other code segments or hardware circuits by sending or receiving information, data, arguments, parameters, or memory contents.

In each of the above-described embodiments, it is explained that the image processing program 30 is stored (installed) in advance in the storage unit 22, but this is not limited to this. The image processing program 30 may be provided in a form recorded on a recording medium such as a CD-ROM (Compact Disc Read Only Memory), DVD-ROM (Digital Versatile Disc Read Only Memory), and USB (Universal Serial Bus) memory. In addition, the image processing program 30 may be provided in a form that the image processing program 30 is downloaded from an external device via a network.

In each of the above-described embodiments, it is explained that the image processing program 70 is stored (installed) in advance in the storage unit 62, but this is not limited to this. The image processing program 70 may be provided in a form recorded on a recording medium such as a CD-ROM, DVD-ROM, and USB memory. In addition, the image processing program 30 may be provided in a form that the image processing program 70 is downloaded from an external device via a network.

The technology of this disclosure also extends to all types of program products. Program products include all types of products for providing programs. For example, program products include programs provided via networks such as the Internet, and non-temporary computer readable storage media such as CD-ROMs, DVDs, and USB memory devices that store programs.

In regard to the above-described embodiments, the supplementary notes will be further disclosed as follows.

### Supplementary Note 1

An image processing apparatus comprising: a processor, in which the image processing apparatus trains a machine learning model that receives input of a first two-dimensional medical image to output an organ recognition result for the first two-dimensional medical image, and the processor is configured to: generate a second two-dimensional medical image based on a three-dimensional medical image obtained by imaging a subject; and train the machine learning model using, as ground truth data, the generated second two-dimensional medical image and an organ recognition result corresponding to the second two-dimensional medical image based on an organ recognition result in the three-dimensional medical image.

### Supplementary Note 2

The image processing apparatus according to supplementary note 1, in which the three-dimensional medical image includes a tomographic image group obtained by imaging the subject, and the processor is configured to: generate, based on a first three-dimensional medical image, a second three-dimensional medical image having a narrower slice interval or a thinner slice thickness than the first three-dimensional medical image; and generate the second two-dimensional medical image based on the second three-dimensional medical image.

### Supplementary Note 3

The image processing apparatus according to supplementary note 2, in which the processor is configured to: generate the second two-dimensional medical image by projecting the second three-dimensional medical image in a direction corresponding to an imaging direction of the first two-dimensional medical image.

### Supplementary Note 4

The image processing apparatus according to supplementary note 3, in which the processor is configured to: generate the second two-dimensional medical image by performing image processing of enhancing an edge based on the second three-dimensional medical image.

### Supplementary Note 5

The image processing apparatus according to supplementary note 4, in which the processor is configured to: generate a projection image by projecting the second three-dimensional medical image in the direction corresponding to the imaging direction and generate the second two-dimensional medical image by performing the image processing on the projection image.

### Supplementary Note 6

The image processing apparatus according to supplementary note 4 or 5, in which the processor is configured to: perform different image processing depending on an imaging apparatus used to capture the first three-dimensional medical image or on an organ that is a recognition target.

### Supplementary Note 7

The image processing apparatus according to any one of supplementary notes 1 to 6, in which the organ recognition result is information indicating a range of a recognized organ.

### Supplementary Note 8

The image processing apparatus according to any one of supplementary notes 1 to 7, in which the processor is configured to: further train the machine learning model using examination information in a case in which the three-dimensional medical image is captured.

### Supplementary Note 9

The image processing apparatus according to any one of supplementary notes 1 to 8, in which the processor is configured to: further train the machine learning model using biological information of the subject in a case in which the three-dimensional medical image is captured.

### Supplementary Note 10

The image processing apparatus according to supplementary note 9, in which the machine learning model receives input of the first two-dimensional medical image and the biological information to output the organ recognition result.

### Supplementary Note 11

An image processing method executed by a processor of an image processing apparatus that includes the processor and that trains a machine learning model that receives input of a first two-dimensional medical image to output an organ recognition result for the first two-dimensional medical image, the image processing method comprising: generating a second two-dimensional medical image based on a three-dimensional medical image obtained by imaging a subject; and training the machine learning model using, as ground truth data, the generated second two-dimensional medical image and an organ recognition result corresponding to the second two-dimensional medical image based on an organ recognition result in the three-dimensional medical image.

### Supplementary Note 12

An image processing program causing a processor of an image processing apparatus that includes the processor and that trains a machine learning model that receives input of a first two-dimensional medical image to output an organ recognition result for the first two-dimensional medical image, to execute a process comprising: generating a second two-dimensional medical image based on a three-dimensional medical image obtained by imaging a subject; and training the machine learning model using, as ground truth data, the generated second two-dimensional medical image and an organ recognition result corresponding to the second two-dimensional medical image based on an organ recognition result in the three-dimensional medical image.

### Supplementary Note 13

An image processing apparatus comprising: a processor, in which the processor is configured to: acquire a two-dimensional medical image obtained by imaging a subject; and acquire an organ recognition result for the acquired two-dimensional medical image by inputting the acquired two-dimensional medical image to a trained model that receives input of a first two-dimensional medical image to output an organ recognition result for the input first two-dimensional medical image, the trained model having been trained using, as ground truth data, a second two-dimensional medical image generated based on a three-dimensional medical image obtained by imaging the subject and an organ recognition result corresponding to the second two-dimensional medical image based on an organ recognition result in the three-dimensional medical image.

### Supplementary Note 14

An image processing method executed by a processor of an image processing apparatus including the processor, the image processing method comprising: acquiring a two-dimensional medical image obtained by imaging a subject; and acquiring an organ recognition result for the acquired two-dimensional medical image by inputting the acquired two-dimensional medical image to a trained model that receives input of a first two-dimensional medical image to output an organ recognition result for the input first two-dimensional medical image, the trained model having been trained using, as ground truth data, a second two-dimensional medical image generated based on a three-dimensional medical image obtained by imaging the subject and an organ recognition result corresponding to the second two-dimensional medical image based on an organ recognition result in the three-dimensional medical image.

### Supplementary Note 15

An image processing program causing a processor of an image processing apparatus including the processor, to execute a process comprising: acquiring a two-dimensional medical image obtained by imaging a subject; and acquiring an organ recognition result for the acquired two-dimensional medical image by inputting the acquired two-dimensional medical image to a trained model that receives input of a first two-dimensional medical image to output an organ recognition result for the input first two-dimensional medical image, the trained model having been trained using, as ground truth data, a second two-dimensional medical image generated based on a three-dimensional medical image obtained by imaging the subject and an organ recognition result corresponding to the second two-dimensional medical image based on an organ recognition result in the three-dimensional medical image.

What is claimed is:

1. An image processing apparatus comprising:
a processor,
wherein the image processing apparatus trains a machine learning model that receives input of a first two-dimensional medical image to output an organ recognition result for the first two-dimensional medical image, and
the processor is configured to:
generate a second two-dimensional medical image based on a three-dimensional medical image obtained by imaging a subject; and
train the machine learning model using, as ground truth data, the generated second two-dimensional medical image and an organ recognition result corresponding to the second two-dimensional medical image based on an organ recognition result in the three-dimensional medical image.

2. The image processing apparatus according to claim 1,
wherein the three-dimensional medical image includes a tomographic image group obtained by imaging the subject, and
the processor is configured to:
generate, based on a first three-dimensional medical image, a second three-dimensional medical image having a narrower slice interval or a thinner slice thickness than the first three-dimensional medical image; and
generate the second two-dimensional medical image based on the second three-dimensional medical image.

3. The image processing apparatus according to claim 2,
wherein the processor is configured to:
generate the second two-dimensional medical image by projecting the second three-dimensional medical image in a direction corresponding to an imaging direction of the first two-dimensional medical image.

4. The image processing apparatus according to claim 3,
wherein the processor is configured to:
generate the second two-dimensional medical image by performing image processing of enhancing an edge based on the second three-dimensional medical image.

5. The image processing apparatus according to claim 4,
wherein the processor is configured to:
generate a projection image by projecting the second three-dimensional medical image in the direction corresponding to the imaging direction and generate the second two-dimensional medical image by performing the image processing on the projection image.

6. The image processing apparatus according to claim 4,
wherein the processor is configured to:
perform different image processing depending on an imaging apparatus used to capture the first three-dimensional medical image or on an organ that is a recognition target.

7. The image processing apparatus according to claim 1,
wherein the organ recognition result is information indicating a range of a recognized organ.

8. The image processing apparatus according to claim 1,
wherein the processor is configured to:
further train the machine learning model using examination information in a case in which the three-dimensional medical image is captured.

9. The image processing apparatus according to claim 1,
wherein the processor is configured to:
further train the machine learning model using biological information of the subject in a case in which the three-dimensional medical image is captured.

10. The image processing apparatus according to claim 9,
wherein the machine learning model receives input of the first two-dimensional medical image and the biological information to output the organ recognition result.

11. An image processing method executed by a processor of an image processing apparatus that includes the processor and that trains a machine learning model that receives input of a first two-dimensional medical image to output an organ recognition result for the first two-dimensional medical image, the image processing method comprising:
generating a second two-dimensional medical image based on a three-dimensional medical image obtained by imaging a subject; and
training the machine learning model using, as ground truth data, the generated second two-dimensional medical image and an organ recognition result corresponding to the second two-dimensional medical image based on an organ recognition result in the three-dimensional medical image.

12. A non-transitory computer-readable storage medium storing an image processing program causing a processor of an image processing apparatus that includes the processor and that trains a machine learning model that receives input of a first two-dimensional medical image to output an organ recognition result for the first two-dimensional medical image, to execute a process comprising:
generating a second two-dimensional medical image based on a three-dimensional medical image obtained by imaging a subject; and
training the machine learning model using, as ground truth data, the generated second two-dimensional medical image and an organ recognition result corresponding to the second two-dimensional medical image based on an organ recognition result in the three-dimensional medical image.

13. An image processing apparatus comprising:
a processor,
wherein the processor is configured to:
acquire a two-dimensional medical image obtained by imaging a subject; and
acquire an organ recognition result for the acquired two-dimensional medical image by inputting the acquired two-dimensional medical image to a trained model that receives input of a first two-dimensional medical image to output an organ recognition result for the input first two-dimensional medical image, the trained model having been trained using, as ground truth data, a second two-dimensional medical image generated based on a three-dimensional medical image obtained by imaging the subject and an organ recognition result corresponding to the second two-dimensional medical image based on an organ recognition result in the three-dimensional medical image.

14. An image processing method executed by a processor of an image processing apparatus including the processor, the image processing method comprising:
acquiring a two-dimensional medical image obtained by imaging a subject; and
acquiring an organ recognition result for the acquired two-dimensional medical image by inputting the acquired two-dimensional medical image to a trained model that receives input of a first two-dimensional medical image to output an organ recognition result for the input first two-dimensional medical image, the trained model having been trained using, as ground truth data, a second two-dimensional medical image generated based on a three-dimensional medical image obtained by imaging the subject and an organ recognition result corresponding to the second two-dimensional medical image based on an organ recognition result in the three-dimensional medical image.

15. A non-transitory computer-readable storage medium storing an image processing program causing a processor of an image processing apparatus including the processor, to execute a process comprising:
acquiring a two-dimensional medical image obtained by imaging a subject; and
acquiring an organ recognition result for the acquired two-dimensional medical image by inputting the acquired two-dimensional medical image to a trained model that receives input of a first two-dimensional medical image to output an organ recognition result for the input first two-dimensional medical image, the trained model having been trained using, as ground truth data, a second two-dimensional medical image generated based on a three-dimensional medical image obtained by imaging the subject and an organ recognition result corresponding to the second two-dimensional medical image based on an organ recognition result in the three-dimensional medical image.
